(19) United States
(12) Patent Application Publication
(10) Pub. No.: US 2025/0371092 A1
(43) Pub. Date: Dec. 4, 2025

(54) SECURING EMBEDDED LINK ACCESS IN EMAILS USING ISOLATION CONTEXT

(71) Applicant: Palo Alto Networks, Inc., Santa Clara, CA (US)

(72) Inventors: Jayant Jain, Cupertino, CA (US); Yanggui Chen, San Jose, CA (US); Fred Philip Stanley, San Jose, CA (US); Priyanka Tiwari, Milpitas, CA (US); Shyam Prasad Nukala, Cupertino, CA (US); Nitish Kishore Khadke, Redwood City, CA (US)

(21) Appl. No.: 18/680,885

(22) Filed: May 31, 2024

(51) Int. Cl. G06F 16/955; G06F 16/908; G06F 40/205

(52) U.S. Cl. CPC G06F 16/9566; G06F 16/908; G06F 40/205

(57) ABSTRACT

The present application discloses a method, system, and computer system for providing secure access to links embedded in an email. The method includes (i) parsing an email, (ii) identifying a URL link in the email, and (iii) rewriting the URL link for execution in an isolation context based at least in part on a policy.

### BACKGROUND OF THE INVENTION

In today's interconnected digital landscape, email serves as a primary communication channel for individuals and businesses alike. However, the pervasive use of email also makes it a prime target for cybercriminals seeking to exploit vulnerabilities and perpetrate various forms of malicious activity. One common tactic employed by attackers is the use of deceptive emails containing hyperlinks or URLs that lead to fraudulent websites, phishing portals, or malware-infected destinations. Unsuspecting users who click on these links may inadvertently compromise sensitive information, expose their systems to malware, or become victims of identity theft.

Traditional email security solutions typically rely on static filtering mechanisms, such as blacklists, whitelists, and signature-based detection, to identify and block known threats. While these approaches can offer some level of protection, they often struggle to keep pace with the rapidly evolving tactics employed by cyber adversaries. Moreover, sophisticated attackers may employ evasion techniques to bypass these static defenses, rendering them ineffective against novel or previously unseen threats.

### BRIEF DESCRIPTION OF THE DRAWINGS

Various embodiments of the invention are disclosed in the following detailed description and the accompanying drawings.

FIG. 1 is a block diagram of an environment in which a link embedded in a communication is provided in a secure manner according to various embodiments.

FIG. 2 is a block diagram of a system for processing emails to secure embedded links according to various embodiments.

FIGS. 3A and 3B are block diagrams of a system for processing emails to secure embedded links according to various embodiments.

FIG. 4 is a flow diagram of a method for enforcing a policy to be applied with respect to an ingress communication according to various embodiments.

FIG. 5 is a flow diagram of a method for processing an egress communication to unwind enforcement of a particular policy according to various embodiments.

FIG. 6 is a flow diagram of a method for intercepting a communication and processing an embedded link(s) according to various embodiments.

FIG. 7 is a flow diagram of a method for intercepting an ingress communication and processing an embedded link(s) according to various embodiments.

FIG. 8 is a flow diagram of a method for rewriting an embedded link(s) in an ingress communication according to various embodiments.

FIG. 9 is a flow diagram of a method for accessing an embedded link in a communication according to various embodiments.

FIG. 10 is a flow diagram of a method for accessing an embedded link in a communication according to various embodiments.

FIG. 11 is a flow diagram of a method for intercepting an egress communication and processing an embedded link(s) according to various embodiments.

FIG. 12 is a flow diagram of a method for processing an embedded link(s) for an egress communication according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Links embedded in emails pose a major threat to enterprise through various vectors, particularly emails/links accessible on unmanaged devices. Because emails or other communications (e.g., instant messages, etc.) are typically accessible on unmanaged devices such as personal laptops, phones, etc., to provide the users with secure access to the emails and embedded links, various embodiments inspect these links through an enterprise grade security infrastructure. According to various embodiments, the system intercepts these links (e.g., intercepts the communication such as email) and inspects the links based upon a prescribed policy (e.g., a policy applicable to the intended recipient, such as a policy predefined for the user or tenant with which the user is associated). The system routes the links through an isolation context service that isolates the accessing of such links to inspect the links or content hosted at the corresponding address.

Given the rise in malware being distributed through weblinks delivered through emails, it has become critical that any high risk link received through this medium be properly inspected by security infrastructure (e.g., security devices). Because not all email clients are running on managed devices (e.g., a managed device forces the access of the link through the default security devices), redirection of the link through security services is critical to ensure security even on unmanaged devices. Some related art solutions rewrite the incoming links and present their global proxy as the gateway for these links. However, the deep inspection of various embodiments described herein achieve using isolation context service (e.g., remote browser isolation (RBI) and security gateways is unparalleled. Additionally, related art systems do not rewrite and process the links. Various embodiments can process embedded links based on the context of tenant and user based policies and/or the category of embedded links (e.g., news, sports, finance, company confidential information, gambling sites, adult material, etc.). The system described herein can provide secure access to a variety of embedded links in terms of categories and has the ability to process the link in the context of tenant and user based policies.

Various embodiments provide a method, system, and computer system for providing emails comprising embedded URL links. In some embodiments, the system provides secure access to links (e.g., URL links) embedded in an email. The method includes (i) parsing an email, (ii) identifying a URL link in the email, and (iii) rewriting the URL link for execution in an isolation context based at least in part on a policy.

Various embodiments provide a method, system, and computer system for providing emails comprising embedded URL links. In some embodiments, the system rewrites embedded URL links before sending an email. The method includes (i) receiving a request to send an email comprising one or more rewritten URL links, (ii) determining a policy to enforce with respect to a sending of the email, (iii) rewriting the one or more rewritten URL links based at least in part on the policy to be enforced with respect to the sending of the email, (iv) modify the email based on the rewriting of the one or more rewritten URL links, and (v) causing the email to be sent.

In some embodiments, the system rewrites links based upon a set of rules dependent on the context associated with the communication (e.g., an intercepted email for which embedded links are being processed). The system can rewrite the links based on multiple factors such as the sender, receiver, the category(ies) embedded in the links, or the organization, domain, or tenant associated with the sender or receiver. The system can process one or both of ingress communications and egress communications. For example, the system intercepts the communications before the communication is delivered to the intended recipient, and processes the embedded links to ensure that that the embedded links are secure or to otherwise sanitize the content provided to the intended recipient (e.g., to hide/redact information for which the intended recipient does not have the requisite permissions, such as for an organization's confidential information, etc.).

The rewritten links described herein are configured to enable the links to be securely accessed. In some implementations, when a rewritten link is clicked/selected (e.g., by a user at a client system), the accessing of the links is routed through a security service. For example, the accessing of the link is routed through the tenant-specific isolation context service (e.g., an RBI stack) as well as a security gateway infrastructure after user authentications. Accordingly, the system has the ability to securely carry context in the rewritten links in a stateless manner, which is not available from related art systems.

The system can also be configured with the ability to undo the rewrites (e.g., of embedded links) on the communication (e.g., the email) egressing from the current address. For example, the system can unwind/remove the rewritten URL links (and replace them with the URL links in the initial ingress email) for emails egressing outside organization boundary, such as to remove the redirect available for devices within the specific organization (e.g., tenant) but that are not available for devices/users not within or associated with the organization.

Administrators can define/create a policy specifying URL categories and groups/users for which embedded links received in an email are to be configured to comprise a redirect to a security service for secure accessing of the URL links and/or policy enforcement with respect to accessing the URL links. The system allows for the interception of inbound emails to users and the rewriting/obfuscation of the URL link(s) to make the users access the link through an isolation stack (e.g., an isolation context service) provisioned for that customer/tenant.

In some embodiments, in response to receipt of an inbound email (e.g., an ingress communication), the email is marked with an header “inbound” or other similar identifier/association. These emails (e.g., the emails marked as “inbound”), after persistence to the organization's cloud service/storage, are intercepted by an email processing engine (e.g., a remote email processing service (RES). The email processing engine is configured to preprocess the email content such as by using Mime Parsers (e.g., only with respect to the text and html section of the email). The email processing engine extracts from the email user information, such as the user identifier (e.g., user ID) and various embedded links. The system (e.g., the RES) can call a policy engine with the data, such as in response to determining that the email comprises embedded links (e.g., URL links). The policy engine can query a set of policies based on the context, such as the user identifier and/or applicable tenant identifier. The system (e.g., the policy engine) can query an advanced URL filtering (AUF) service with the list of links identified by the email processing engine. The system uses the results from querying the set of policies for the applicable policy and the results of the AUG to process the data through the policy engine and mark for each link whether to the link is to be rewritten. In response to determining that a link is to be rewritten, the system rewrites the link, such as by generating an envelope data structure to comprise the address associated with the link and context information (e.g., one or more of a user identifier, a tenant identifier, a policy or rule within a policy to be enforced, a category of the link, redirect information such as a destination to which accessing the link is to be redirected for the security service, etc.). As an example, the rewritten links are shortened links (e.g., base 62 encoded and stored in a lookable cloud native database with link expiry) for each link that needs to be written. In some embodiments, the envelope data structure is a JSON web token (JWT), which comprises the context such as tenant identifier, user identifier, link (or address associated with the link, in some embodiments, arguments). In response to rewriting the link(s) for an email, the system updates the email to include the rewritten links (e.g., to replace the initial/unprocessed URL links with the rewritten links) and provides the email to the inbox for the intended recipient, for example, by forwards the email back to the configured email server. In some embodiments, in the case of distribution lists (DL) and/or multiple recipients, the system (e.g., the email server) delivers the email per recipient so that personalized policies can be made applicable (e.g., the links in an email for a particular recipient are rewritten based on policies specific to the particular recipient). For example, the system generates a rewritten link specifically for each user, or groups of users having the same applicable policies.

In some embodiments, the system performs outbound processing for egress emails (e.g., the emails comprising links that have been rewritten as described herein, such as to be redirected to an isolation context service). For example, the system intercepts egress emails and before the sending of the email, the system unwinds (e.g., undoes) the rewriting of each applicable link such as in the event that the destination for the outbound email is outside the domain or organization. As another example, in response to determining that the egress email is destined to another user within the domain (e.g., the intended recipient is within the same organization), the system can process the email to rewrite the rewritten links (e.g., to generate a corresponding set of new rewritten links that are configured for the new context, such as to be configured for the policies applicable to the intended recipient). In some embodiments, in connection with processing the outbound emails, an email data loss prevention (EDLP) service will include the email processing engine (e.g., the RES) in its service. Because the email processing engine changes the content of the email (e.g., rewrites the embedded links), the email processing engine is invoked before other outbound processing (e.g., other EDLP service) are invoked. The email processing engine can be configured to: (a) in response to receiving an outbound email, parse the email, (b) extract all links which have been rewritten (e.g., based upon regex); (c) open up the content of the encoded section (e.g., after a database lookup) and JWT parsing; (d) rewrite the original links (or generate rewritten links comprising a new envelope data structure for the intended recipient, such as in the case that the system is to enforce policies for the intended recipient); (e) notify EDLP of the processing; and (f) in response to completing the pre-processing, the EDLP can provide additional services.

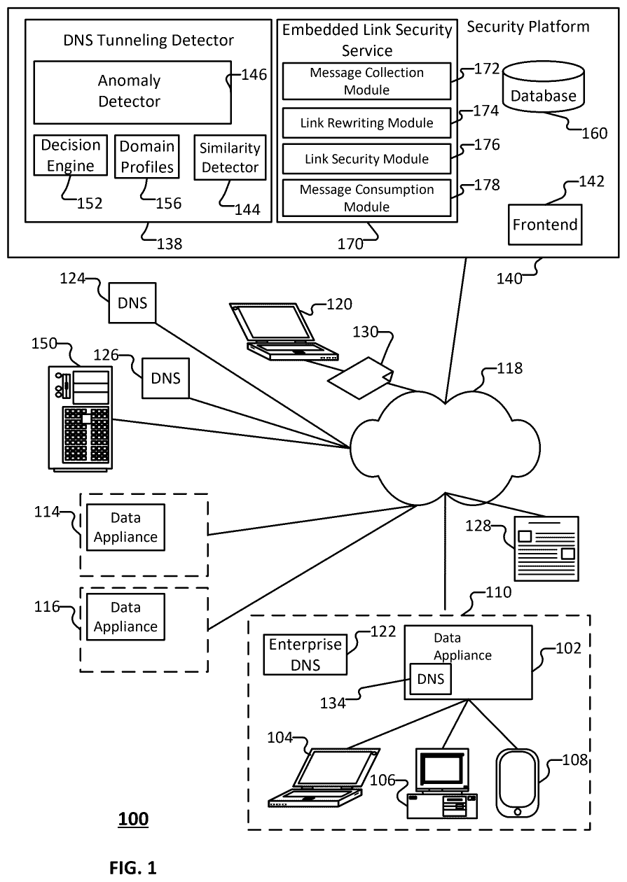

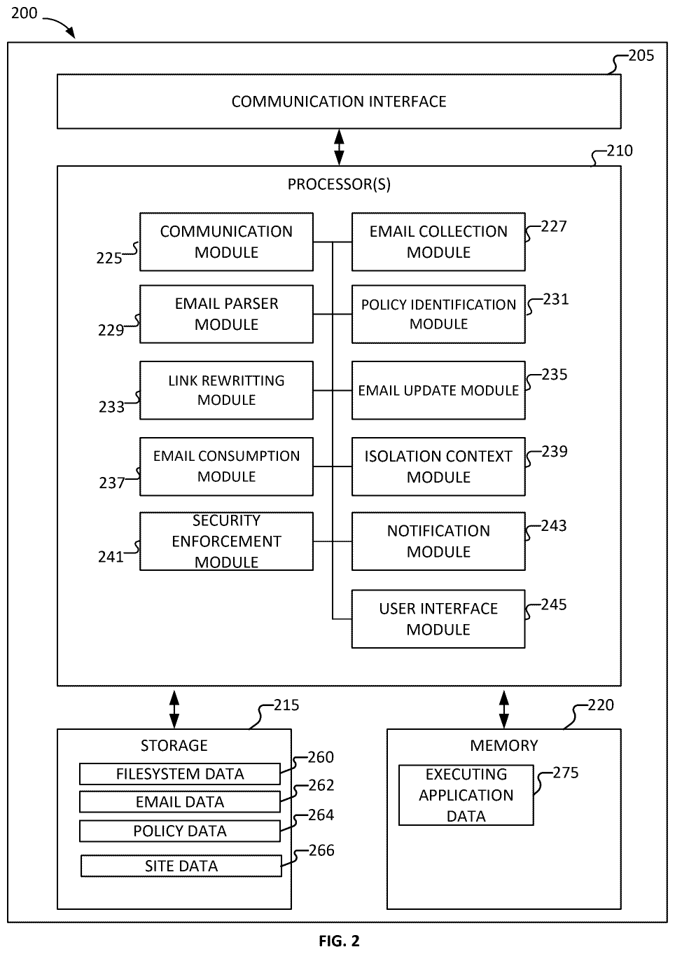

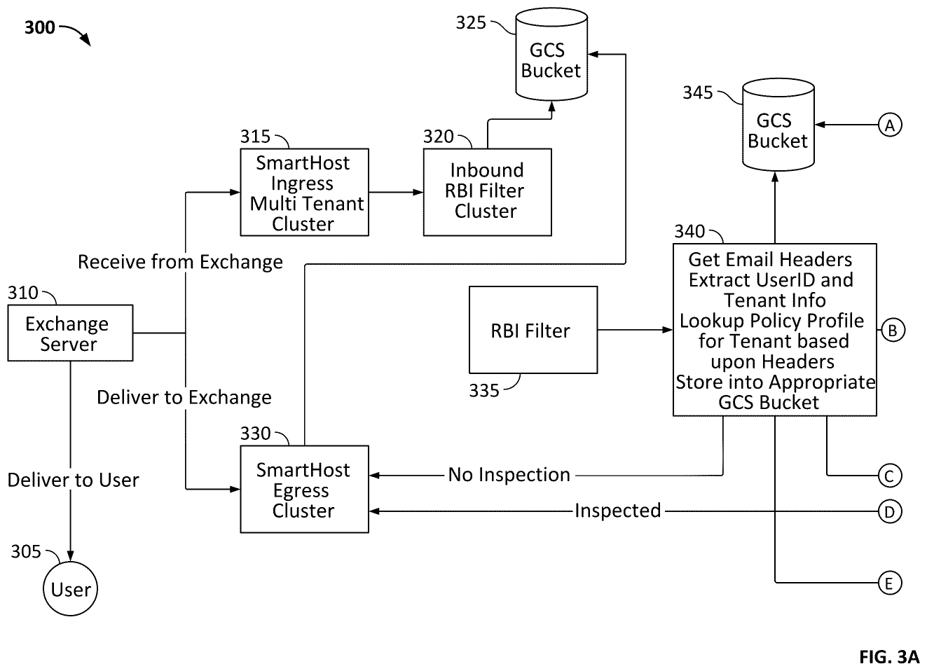

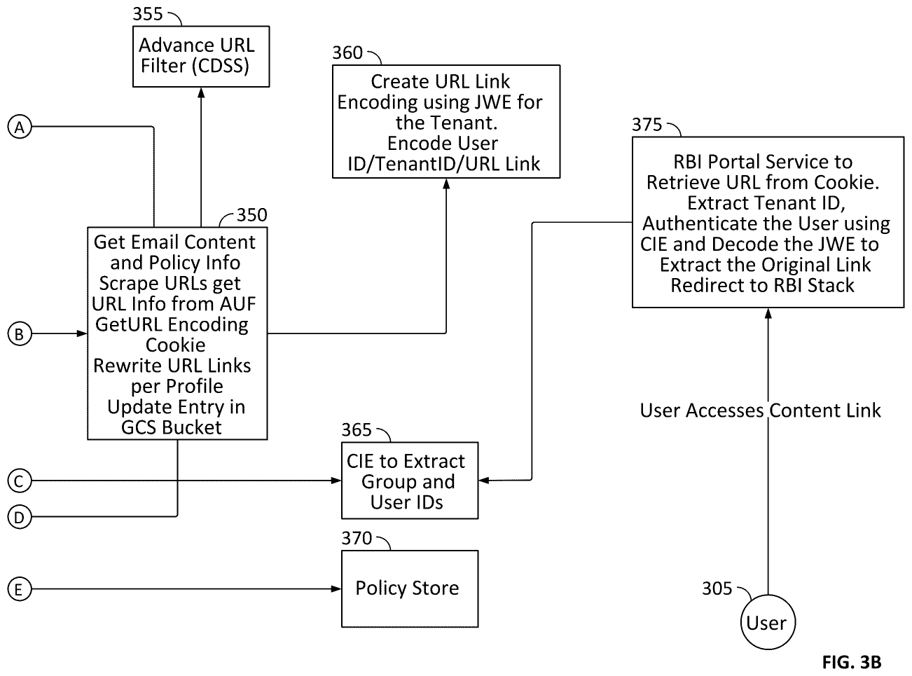

FIG. 1 is a block diagram of an environment in which a link embedded in a communication is provided in a secure manner according to various embodiments. In some embodiments, system 100 is implemented by at least part of system 200 of FIG. 2, and/or system 300 of FIGS. 3A and 3B. In some embodiments, system 100 can implement one or more of processes 400-1200 of FIG. 412.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains or parked domains, or traffic for certain applications (e.g., SaaS applications), or malicious or invalid authentication requests. In some embodiments, data appliance 102 is also configured to enforce policies with respect to traffic that stays within (or from coming into) enterprise network 110.

Techniques described herein can be used in conjunction with a variety of platforms (e.g., desktops, mobile devices, gaming platforms, embedded systems, etc.) and/or a variety of types of applications (e.g., Android.apk files, iOS applications, Windows PE files, Adobe Acrobat PDF files, Microsoft Windows PE installers, etc.). In addition, the techniques described herein can be implemented in connection with providing secure access to emails on unmanaged devices. In the example environment shown in FIG. 1, client devices 104-108 are a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including network security services, sample grouping (e.g., grouping domains), pattern candidate extraction, training/updating classifiers (e.g., machine learning models such as to provide a predicted maliciousness classification for samples, for example, domains), enforce one or more security policies, provide secure access to links embedded in emails, etc. Security platform 140 can use unsupervised data stored in a database (e.g., collected based on intercepting traffic communicated across a network) to identify patterns and train/update a model to detect emergent exploits (e.g., malicious domains, phishing campaigns, and the like). Security platform 140 can process communications (e.g., emails) to rewrite embedded links to enforce a security policy with respect to accessing the embedded links. For example, security platform 140 configures the embedded links to cause the accessing of the link to be redirected to a security service, such as a service that provides an isolation context service (e.g., to access the links in an isolation context and to enforce security policies with respect to the content hosted at the address).

According to various embodiments, examples of services provided by security platform 140 include (a) managing/maintaining a security policy configuration(s) for enterprise network 110 and/or devices connected to enterprise network 110 (e.g., managed devices, security entities, etc.), (b) enforcing the security policy configuration or causing a security entity (e.g., a firewall) to enforce the security policy configuration, (c) classifying network traffic, (d) classifying authentication requests and/or connection requests, (e) determining a manner by which authentication requests and/connection requests are to be handled (e.g., based at least in part on a predicted authentication classification, etc.), (f) training a machine learning (ML) model to generate predictions with respect to network traffic classifications, (g) grouping samples based on a set of corresponding images, (h) parsing communications (e.g., ingress and/or egress emails), (i) identifying embedded links in communications (e.g., links included in an instant message or an email, etc.), (j) rewriting an embedded link to provide a redirect to a security service (e.g., a redirect to an isolation context service) or otherwise rewriting the embedded link to enforce one or more policies, and/or (k) performing an active measure with respect to network traffic (e.g., authentication requests) or files communicated across the network such as based on an instruction from another service or system or based on security platform 140 using a classifier (e.g., an ML model, a rule-based model, etc.) to generate a prediction with respect to the network traffic (e.g., a prediction of whether the network traffic, or session data for a particular traffic protocol, is malicious).

Security platform 140 may implement other services, such as determining an attribution of network traffic to a particular DNS tunneling campaign or tool, indexing features or other DNS-activity information with respect to particular campaigns or tools (or as unknown), classifying network traffic (e.g., identifying application(s) to which particular samples of network traffic corresponding, determining whether traffic is malicious, detecting malicious traffic, detecting C2 traffic, etc.), providing a mapping of signatures to certain traffic (e.g., a type of C2 traffic,) or a mapping of signatures to applications/application identifiers (e.g., network traffic signatures to application identifiers), providing a mapping of IP addresses to certain traffic (e.g., traffic to/from a client device for which C2 traffic has been detected, or for which security platform 140 identifies as being benign), performing static and dynamic analysis on malware samples, assessing maliciousness of domains, determining whether domains are parked domains, providing a list of signatures of known exploits (e.g., malicious input strings, malicious files, malicious domains, etc.) to data appliances, such as data appliance 102 as part of a subscription, detecting exploits such as malicious input strings, malicious files, or malicious domains (e.g., an on-demand detection, or periodical-based updates to a mapping of domains to indications of whether the domains are malicious or benign), providing a likelihood that a domain is malicious (e.g., a parked domain) or benign (e.g., an unparked domain), determining and/or providing an indication or a likelihood that authentication request is malicious, determining and/or providing an indication or a likelihood that network traffic for a particular traffic protocol (e.g., HTTP session data) is malicious, determining a model score, providing/updating a whitelist of input strings, files, domains, source addresses, destination address, authentication requests, or other characteristics or attributes of network traffic deemed to be benign, providing/updating input strings, files, domains, source addresses, destination address, authentication requests, or other characteristics or attributes of network traffic deemed to be malicious, identifying malicious input strings, detecting malicious input strings, detecting malicious files, predicting whether input strings, files, or domains are malicious, and providing an indication that an input string, file, or domain is malicious (or benign).

In some embodiments, embedded link security service 170 is a service for providing secure access to links embedded in communications (e.g., ingress and/or egress emails, etc.). Embedded link security service 170 can use a rewriting of embedded links in communications (e.g., emails, instant messages, etc.) to redirect the accessing of the links to a security service (e.g., a service that provides an isolation context service), which can enforce policies in connection with providing a client system (e.g., an unmanaged device) access to the link. Embedded link security service 170 updates the communication to comprise the rewritten link(s), for example, by replacing the initial embedded link(s) with the rewritten link(s). After updating the communication, embedded link security service 170 can cause the updated communication to be sent (e.g., stored, provided, etc.) to the intended recipient (e.g., the updated email is provided to the intended recipient's inbox).

In response to a rewritten link being selected (e.g., at the client device for the user accessing the updated communication), embedded link security service 170 can access the link in an isolation context (e.g., based on a query/request being sent from the client device upon selection of the rewritten link). For example, embedded link security service 170 deploys (e.g., instantiates) an isolated environment (e.g., a container or virtual machine in a cluster) within which the link is accessed and the content hosted at the link is inspected. Embedded link security service 170 can enforce one or more policies in connection with returning content hosted at the link to the client system (e.g., the unmanaged device from which the user attempts to access the link). Before providing the security service, the system can authenticate the user after which embedded links security service 170 can be invoked to provide the security service.

Authentication takes place both from validating only a user for whom the link is valid for can access the link (e.g., the rewritten link). Once authentication is successful, the system open up the encrypted part of the data which has the actual original link. For example, the system decrypts/decodes the envelope data structure (e.g., the JWT) to obtain the actual link. The system can extract the original link and other metadata from the envelope data structure, send a response in that JavaScript to the client from the browser context in which the link is clicked, and from that JavaScript the redirection is performed.

In some embodiments, the envelope data structure (e.g., the JWT) embeds a policy identifier(s), which can be passed to the isolation context to be applied to the particular user or link, or content accessible at the link. The envelope data structure may also include container information or other information that is indicative of the particular server(s) or clusters to be used to provide the isolation context. The envelope data structure can be encrypted using a key associated with a tenant (e.g., the tenant referenced in the context information for the email or link embedded therein).

Although the example shows that security platform 140 comprises embedded link security service 170, in various other embodiments, the embedded link security service 170 may be implemented by another server(s)/service.

Security platform 140 may be further configured to classify network traffic, such as to determine whether the traffic is malicious or benign, or to determine a likelihood that the traffic is malicious or benign. Security platform 140 can store one or more classifiers (e.g., rule-based models, machine learning models, etc.). For example, Security platform 140 implements a classifier for predicting whether authentication requests, connection requests, or domains (e.g., received from a proxy or client device) are malicious/benign. Security platform 140 can further store/implement one or more security policies, such as a traffic-handling policy, according to which security platform 140 causes the network traffic (e.g., the authentication requests) to be handled.

In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remainder portions of security platform 140 provided by dedicated hardware owned by and under the control of the operator of security platform 140.

In some embodiments, embedded link security service 170 is implemented to provide security services to unmanaged devices. Embedded link security service 170 can intercept communications to various services (e.g., emails, instant messages, collaboration tools, etc.) and configure links embedded in the intercepted communications based at least in part on context information (e.g., the associated user identifier, tenant identifier, category of links, etc.).

The techniques implemented by embedded link security service 170 ensures that users associated with an organization for which a security service is provided (e.g., a tenant, a domain, etc.) can securely access links embedded in the communication, even without the device being managed by an enterprise security service (e.g., an application installed locally that enables enterprise administrators to secure the device).

In some embodiments, embedded link security service 170 implements one or more techniques for ensuring secure access to links embedded in communications to a particular domain or across an organization's network. The communications can be intercepted and configured to provide secure access to links embedded therein. In the example shown, embedded link security service 170 comprises message collection module 172, link rewriting module 174, link security module 176, and message consumption module 178.

Embedded link security service 170 uses message collection module 172 to collect messages across a network (e.g., to a domain or organization's network, such as ingress and egress communications to an email server). Message collection module 172 can intercept the communications before they are delivered to the intended recipient (e.g., to an email server or email application that connects to an email server) or before the message is sent from a user's account (e.g., before the communication exits the domain or before the communication is provided to another user within the same domain). Communication collection module 172 can obtain various types of communications, and can obtain the communications during interception of network traffic by security platform 140 or by a firewall or other node in system 100. Examples of communications include emails, instant messages, collaboration tool pages, etc.

Embedded link security service 170 uses link rewriting module 174 to rewrite links embedded in intercepted communications to configure the links to be accessed via security service such as an isolation context. In response to the communication being intercepted, embedded link security service 170 can parse the communication, identify links embedded in the communication, and context pertaining to the communication (e.g., a user identifier, such as for the intended recipient, a tenant identifier or other customer/domain identifier, etc.). Embedded link security service 170 can perform a policy lookup based at least in part on the context in order to identify one or more policies that are to be enforced for the context, such as policies applicable to the user (e.g., the intended recipient), the tenant, and/or a category associated with the embedded links. Embedded link security service 170 rewrites the links to cause an attempt to navigate to the link to be redirected through the security service provided by security platform 140. For example, embedded link security service 170 generates an envelope data structure (e.g., JWT) based at least in part on the link and the context. The envelope data structure can comprise the user identifier, a tenant identifier, the link, etc. Additionally, the envelope data structure may comprise the particular one or more policies, or rules within the one or more policies, to be enforced with respect to the accessing of the link.

In some embodiments, the rewritten link obfuscates or hides the address associated with the initial/unprocessed link. The rewritten link obfuscates or hides the address to prevent a user from circumventing the security service and directly accessing the address, such as by copying and pasting the URL into a browser navigating to the address. By obfuscating the link/address, the system enforces client systems to have to access the address via a redirection through the security service that enforces one or more security policies. The obfuscation or hiding of the address can include encrypting/encoding the address within an envelope data structure such as a JWT.

Embedded link security service 170 uses link security module 176 to update the communications based on the rewritten links to ensure that the links are securely accessed even by unmanaged devices. In response to the links being rewritten by link rewriting module 174, link security module 176 can update the communication to comprise the rewritten links, such as to replace the unprocessed embedded links with the rewritten links. Thus, link security module 176 modifies the communication to ensure that, upon selection of the link, the client system (e.g., the unmanaged device) does not directly access the domain associated with the link, but instead is redirected to the security service that can access the link on behalf of the client system and provide a security service (e.g., a data lost prevention service) in connection with delivering to the client system content hosted at the address for the link.

Embedded link security service 170 uses message consumption module 178 to provide secure access for consumption of the links, such as to provide secure access to the links in response to a rewritten link within a communication being selected (e.g., a user at the client system attempting to navigate to the link). In response to the rewritten link being selected, the client system is directed to a security service provided by message consumption module 178. For example, message consumption module 178 invokes an isolation context service via which the link is to be accessed. Message consumption module 178 can cause an isolated environment (e.g., a sandbox, such as a container or virtual machine associated with the tenant) to access the link (e.g., the underlying address) and link security module 176 can enforce one or more policies with respect to the content hosted at the domain associated with the link. As an illustrative example, message consumption module 178 can perform a filtering to remove or obfuscate/block malicious or suspicious data, or to otherwise filter out data for which the user does not have appropriate permissions. Message consumption module 178 enforces the one or more policies for the context comprised in the rewritten link (e.g., the user identifier, the tenant identifier, the category of links, etc.).

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

The environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious samples, detecting parked domains, or otherwise determining that certain detected network traffic is to be further analyzed (e.g., using a finer detection model).

In various embodiments, when a client device (e.g., client device 104) attempts to resolve an SQL statement or SQL command, or other command injection string, data appliance 102 uses the corresponding sample (e.g., an input string) as a query to security platform 140. This query can be performed concurrently with the resolution of the SQL statement, SQL command, or other command injection string. As one example, data appliance 102 can send a query (e.g., in the JSON format) to a frontend 142 of security platform 140 via a REST API. Using processing described in more detail below, security platform 140 will determine whether the queried SQL statement, SQL command, or other command injection string indicates an exploit attempt and provide a result back to data appliance 102 (e.g., “malicious exploit” or “benign traffic”).

In various embodiments, when a client device (e.g., client device 104) attempts to open a file or input string that was received, such as via an attachment to an email, instant message, or otherwise exchanged via a network, or when a client device receives such a file or input string, DNS module 134 uses the file or input string (or a computed hash or signature, or other unique identifier, etc.) as a query to security platform 140. In other implementations, an inline security entity queries a mapping of hashes/signatures to traffic classifications (e.g., indications that the traffic is C2 traffic, indications that the traffic is malicious traffic, indications that the traffic is benign/non-malicious, etc.). This query can be performed contemporaneously with receipt of the file or input string, or in response to a request from a user to scan the file. As one example, data appliance 102 can send a query (e.g., in the JSON format) to a frontend 142 of security platform 140 via a REST API. Using processing described in more detail below, security platform 140 will determine (e.g., using a malicious file detector that may use a machine learning model to detect/predict whether the file is malicious) whether the queried file is a malicious file (or likely to be a malicious file) and provide a result back to data appliance 102 (e.g., “malicious file” or “benign file”).

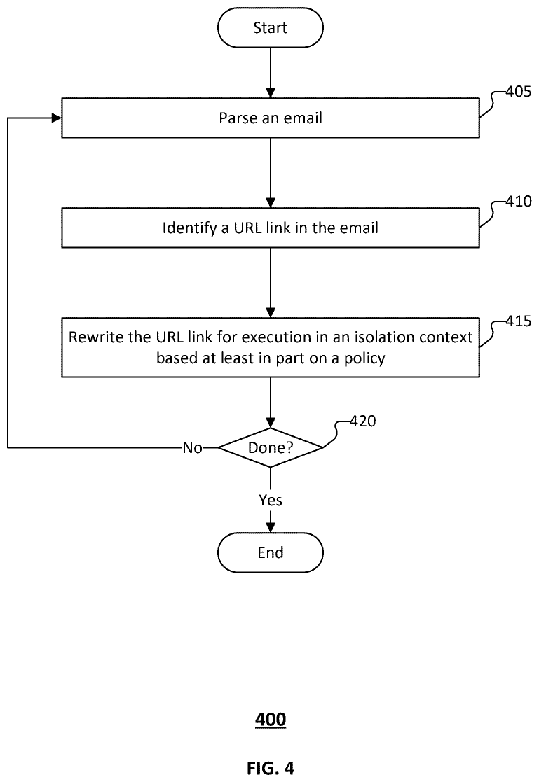

FIG. 2 is a block diagram of a system for processing emails to secure embedded links according to various embodiments. In some embodiments, system 200 is implemented by at least part of system 100 of FIG. 1 and/or system 300 of FIGS. 3A and 3B. In some embodiments, system 200 can implement one or more of processes 400-1200 of FIGS. 4-12. System 200 may be implemented in one or more servers, a security entity such as a firewall, an endpoint, a security service provided as a software as a service.

In some embodiments, system 200 is an entity that intercepts network traffic, namely communications (e.g., emails, instant messages, etc.) and configures the communications to ensure that links embedded in the communications are securely accessed when invoked (e.g., when a user at a client system clicks on the links). System 200 can configure the communication to ensure that navigation to the address associated with the links (e.g., by clicking the links) is rerouted through the security service provided by system 200. System 200 can enforce one or more security policies with respect to the rerouted/redirected requests to access the address, such as by performing data filtering on malicious/suspicious data or data for which the user does not have the requisite permissions.

In the example shown, system 200 implements one or more modules in connection with intercepting communications, parsing the communications, detecting embedded links in the communications, determining a context for the links or communication, rewriting the links based on the context (e.g., based on one or more policies determined to be applicable for the context), receive a request to access the address for the link, accessing the link on behalf of a client system, enforcing a security policy with respect to the accessing of the link (e.g., with respect to the content hosted at address for the link), and/or providing content to the client system (e.g., filtering out malicious/suspicious data and providing the remaining content hosted at the address, if any, to the client system), etc. System 200 comprises communication interface 205, one or more processor(s) 210, storage 215, and/or memory 220. One or more processors 210 comprises one or more of communication module 225, email collection module 227, email parser module 229, policy identification module 231, link rewriting module 233, email update module 235, email consumption module 237, isolation context module 239, security enforcement module 241, notification module 243, and user interface module 245.

In some embodiments, system 200 comprises communication module 225. System 200 uses communication module 225 to communicate with various nodes or end points (e.g., client terminals, firewalls, DNS resolvers, data appliances, other security entities, databases, etc.) or user systems such as an administrator system. For example, communication module 225 provides to communication interface 205 information that is to be communicated (e.g., to another node, security entity, etc.). As another example, communication interface 205 provides to communication module 225 information received by system 200, such as policy data, content hosted at an address/link accessed by or on behalf of system 200, intercepted communications such as emails, context data for communications, etc. Communication module 225 can be configured to receive an indication of historical data (e.g., sample domains and their associated images/screenshots, URLs, HTMLs, etc.) to be analyzed and used to train a classifier for classifying network traffic (e.g., a malicious domain detector, etc.). Communication module 225 is configured to obtain, such as from client devices, remote databases, or other endpoints, samples to be classified or samples to be used to train a classifier. System 200 can use communication module 225 to obtain the samples from a database of unsupervised or unlabeled data. System 200 can use communication module 225 to query the third-party service(s) (e.g., user/device authentication services, remote browser isolation services, etc.) or other systems to obtain information to be used in connection with training a model (e.g., a malicious domain classifier), to generate and provide a request, and/or to determine or recommend an active measure to be implemented based on the forecast. Communication module 225 is further configured to receive one or more settings or configurations from an administrator.

In some embodiments, system 200 comprises email collection module 227. System uses email collection module 227 to intercept emails (e.g., ingress emails and/or egress emails). The email collection module 227 may operate at the network level, utilizing packet sniffing or deep packet inspection techniques to identify and extract email messages from the network traffic stream. Alternatively, email collection module 227 may be integrated into the mail transfer agent (MTA) of the recipient's mail server, and intercept email messages as they are received by the server.

In some embodiments, system 200 comprises email parser module 229. System uses email parser module 229 to parse the intercepted email messages upon interception by email collection module 227. According to various embodiments, email parser module 229 parses the email to identify any embedded links and/or to determine the context for the email (e.g., the user identifier associated with the intended recipient, a domain, a tenant identifier, if any, etc.). Additionally, email parser module 229 may be configured to categorize any identified links embedded in the email message (e.g., determine the category type for each of the embedded links). Examples of categories include news, sports, gambling, adult material, corporate/organization confidential information, etc.

Email parser module 229 can initiate a series of parsing routines aimed at extracting relevant information from the email content, headers, and attachments. Leveraging advanced parsing algorithms and techniques, the module dissects the email message into its constituent parts, enabling granular analysis and manipulation of email data.

Email parser module 229 can implement a multi-layered approach to parsing email content, encompassing text analysis, structural parsing, and semantic interpretation. Text analysis techniques, such as tokenization and part-of-speech tagging, are utilized to identify and categorize individual words and phrases within the email body. Structural parsing algorithms analyze the hierarchical structure of the email message, identifying key elements such as sender, recipient, subject, and body text. Semantic interpretation algorithms infer the meaning and context of email content, enabling the extraction of actionable insights and information.

Email parser module 229 can adapt to diverse email formats and content types. Whether processing plain text messages, HTML-formatted emails, or messages with rich media attachments, the module employs robust parsing strategies to extract relevant data accurately. In some implementations, email parser module 229 is configured with customizable parsing rules and patterns, allowing users to define specific criteria for extracting desired information from email messages. This flexibility enables the email parser module 229 to accommodate a wide range of use cases, from simple text extraction to complex data extraction tasks involving structured and unstructured email content.

In some embodiments, system 200 comprises policy identification module 231. System uses policy identification module 231 to determine one or more policies to enforce with respect to the email, or more specifically, with respect to the accessing of the links embedded in the email message. Policy identification module 231 can perform a policy lookup based at least in part on context information for the email obtained by email parser module 229. For example, policy identification module 2391 can query a policy library to determine policies applicable for the user identifier (or the role of the user associated with the user identifier), policies applicable for the tenant identifier, and/or policies applicable for the categories for the embedded links.

In some embodiments, system 200 comprises link rewriting module 233. System uses link rewriting module 233 to modify the embedded links to redirect users through a security service (e.g., system 200) before the user (e.g., the intended recipient of the email) can access the linked content. In some embodiments, the modifying the embedded links comprises rewriting embedded links.

Link rewriting module 233 can rewrite the embedded links by generating an envelope data structure to comprise information pertaining to the link (e.g., the address associated with the link) and context information for the email. The context information comprised in the envelope data structure can provide information that can be used to determine the policies (or specific rules of a policy) to enforce with respect to the email, or more specifically with respect to accessing the link. For example, the context information can include one or more of a user identifier, a tenant identifier, link category types, an indication of one or more policies to be enforced, a redirection address, etc.

In some embodiments, the envelope data structure is a JWT. The rewritten hyperlink (e.g., the envelope data structure) can obfuscate or hide the address associated with the link to prevent the email recipient from circumventing the security service and directly navigating to the address (e.g., typing the address into a browser rather than clicking on the embedded link).

Link rewriting module 233 modifies the destination URLs of embedded hyperlinks to route users through a predefined security gateway or proxy server. This gateway acts as a safeguard, inspecting the redirected traffic for potential threats, such as phishing sites, malware downloads, or malicious payloads, before allowing access to the original link destination.

Link rewriting module 233 can employ a variety of strategies to rewrite links seamlessly while preserving the user experience and maintaining the integrity of the original email content. Techniques such as URL obfuscation, parameter manipulation, and domain substitution are utilized to generate rewritten URLs. Furthermore, link rewriting module 233 implements intelligent logic to dynamically adjust the rewriting behavior based on contextual factors, such as user identity, email content, and security policies, ensuring adaptive and effective link transformation. By rerouting users through the security service, system 200 provides an additional layer of defense against web-based threats, safeguarding users and organizations from potential security breaches and data loss incidents.

In some embodiments, system 200 comprises email update module 235. System uses email update module 235 to seamlessly integrate rewritten links into intercepted email messages before delivery to the intended recipients via the email server. Email update module 235 is invoked to proactively update intercepted emails with rewritten links (e.g., the rewritten links generated by link rewriting module 233), thereby mitigating potential security risks associated with direct link access.

In some embodiments, system 200 comprises email consumption module 237. System uses email consumption module 237 to handle redirected traffic resulting from the selection of rewritten links within the updated email messages. Email consumption module 237 receives the redirected traffic arising from selection of the rewritten links and ensures that users can safely consume linked content while maintaining a secure computing environment.

Upon selection of a rewritten link by the email recipient, email consumption module 237 receives the resulting network traffic and parses it to determine the contextual relevance of the email and the associated link. For example, email consumption module 237 extracts the envelope data structure (e.g., the JWT) and parses the envelope data structure to determine the address to be accessed and the context information pertaining to the email, which can be used to enforce the applicable policies.

In some embodiments, email consumption module 237 provides secure access to the link by invoking an isolation context (e.g., an isolated environment or sandbox, such as via allocating a container or other virtual machine associated with the tenant identified in the rewritten link, if any). This isolation context ensures that the linked content is accessed within a controlled and secure environment, protecting the user's system from potential threats such as malware, phishing attacks, or data breaches.

By implementing an isolation context for accessing redirected links, email consumption module 237 effectively shields users from the inherent risks associated with external web content while preserving the accessibility and functionality of email communication.

In some embodiments, system 200 comprises isolation context module 239. System uses isolation context module 239 to invoke a secure isolation environment for accessing links redirected through rewritten links (e.g., rewritten URLs) within intercepted email messages. In some embodiments, isolation context module 239 invokes a remote browser isolation (RBI) service that takes control of an application or frame of a browser running on the client system (e.g., the user's device) and passes through the content obtained at the address associated with the link to the extent such content is in accordance with the applicable policies. For example, the policy(ies) being enforced may require filtering of certain content, such as malicious or suspicious content, certain confidential or restricted information of the organization, or other content that is inconsistent with the organization's policies (e.g., gambling sites, adult content, etc.). The RBI can take over the browser frame based on a JavaScript. The JavaScript creates tunnels with the RBI service, and sends out command to infrastructure to spin up a container for this particular user with this particular links, and the container is used to access the particular link and perform any necessary inspection of link data provided at the link. As an example, all processing of html and JavaScript, and the profiles, etc. is implemented in the isolation context provided by a cloud security service. In other words, the browser is essentially a tunnel to another endpoint doing the rendering and all the processing of the HTML.

Isolation context module 239 may be configured with configurable options for defining and configuring isolation environments tailored to the specific security requirements and preferences of users or organizations. One such approach involves the utilization of containerization technology, where each redirected link is accessed within a dedicated container instance isolated from the underlying operating system and network environment. Containerization ensures that any potentially harmful activities initiated by the linked content are contained within the confines of the isolated environment, preventing unauthorized access to system resources and mitigating the risk of malware infection or data exfiltration.

Alternatively, isolation context module 239 can be configured to leverage sandboxing techniques to create isolated execution environments for accessing redirected links. Sandboxing involves constraining the execution of linked content within a restricted environment with limited privileges and access rights. By sandboxing the execution of linked content, the module prevents malicious activities from affecting the broader system while allowing users to interact with the content safely. Sandboxing configurations can be customized to enforce specific security policies and restrictions, such as network access controls, file system isolation, and process monitoring, ensuring comprehensive protection against a wide range of potential threats.

In some embodiments, system 200 comprises security enforcement module 241. System 200 uses security enforcement module 241 to enforce one or more security policies with respect to information such as network traffic, files, linked content, etc. In response to system 200 receiving a request to access a rewritten link, system 200 uses security enforcement module 241 to determine the applicable policies, or rules within the policies, to be enforced when returning content to the user's system. For example, security enforcement module 241 can filter out malicious or suspicious content, hide or redact certain information in accordance with the applicable policies (e.g., confidential information or other restricted information).

System 200 may use security enforcement module 241 to perform an active measure with respect to the network traffic in response to detecting that the selected link is directed to a site comprising malicious or suspicious content. Security enforcement module 241 can classify the site as benign, malicious or suspicious and correspondingly update a whitelist, blacklist, etc. to include the site. Security enforcement module 241 can determine the active measure to be implemented based on a mapping of sample classifications to active measures. For example, the active measure includes enforcing a particular security policy.

Security enforcement module 241 enforces the one or more security policies based on whether the candidate sample (e.g., the intercepted network traffic or associated domain) is malicious. As an example, in the case of system 200 being a security entity (e.g., a firewall) or firewall, system 200 comprises security enforcement module 241. Firewalls typically deny or permit network transmission based on a set of rules. These sets of rules are often referred to as policies (e.g., network policies, network security policies, security policies, etc.). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies. Other examples of policies include security policies such as ones requiring the scanning for threats in incoming (and/or outgoing) email attachments, website content, files exchanged through instant messaging programs, and/or other file transfers.

In some embodiments, system 200 comprises notification module 243. System 200 uses notification module 243 to provide indications pertaining to classification of the site (e.g., alert the user that the embedded link is directed to a malicious site), recommended active measurements, actions taken in enforcing one or more security policies, etc.

In some embodiments, system 200 comprises user interface module 245. System 200 uses user interface module 245 to configure and provide a user interface to a user, such as to a client system used by an administrator. User interface module 245 configures a user interface to provide the notifications or alerts, such as prompting the user of an active measure implemented based on the predicted classification of the site, notifying the user of newly detected patterns, notifying the user of newly detected exploits (e.g., phishing campaigns), alerting the user that the training of the classifier (e.g., a sample classification model) is complete, prompting the user that a malicious traffic is detected or has been handled, prompting the user to select an active measure to be performed with respect to particular traffic, etc.

In some embodiments, system 200 uses user interface module 245 to implement a remote browser isolation service in which an application or frame for an application (e.g., a browser) running on a user device (e.g., an unmanaged client system) is controlled by system 200 and the content within the isolated environment is passed back through to the user device.

According to various embodiments, storage 215 comprises one or more of filesystem data 260, email data 262, policy data 264, and site data 266. Storage 215 comprises a shared storage (e.g., a network storage system) and/or database data.

In some embodiments, filesystem data 260 comprises a database such as one or more datasets. Examples of datasets include datasets comprising information pertaining to network activity, system activity, network services, network security services, network or system configurations, defined policies or policies implemented by a service (e.g., a network security service), previous website classifications (e.g., a blacklist of malicious or suspicious websites), etc. Filesystem data 260 comprises data such as historical information pertaining to HTTP request data or network traffic, network activity, network service data, security service traffic/activity, a whitelist of network traffic profiles (e.g., hashes or signatures for the HTTP request data) or IP addresses deemed to be safe (e.g., not suspicious, benign, etc.), a blacklist of network traffic (e.g., authentication request) profiles deemed to be suspicious or malicious, etc.

In some embodiments, email data 262 comprises data pertaining to one or more emails. The email data 262 comprises emails that are intercepted by system 200. Additionally, email data 262 comprises the data obtained by parsing the intercepted emails including the embedded links, information pertaining to the embedded links, and other context information for the email.

In some embodiments, policy data 264 comprises data pertaining to one or more policies that are enforced with respect to users or organizations (e.g., tenants).

In some embodiments, site data 266 comprises content that is hosted at accessed links. The site data 266 can include isolated/quarantined data, such as malicious or suspicious content, or confidential or restricted data, such as confidential information for the organization, or other data that is restricted for the organization (e.g., gambling content, adult content), etc.

According to various embodiments, memory 220 comprises executing application data 275. Executing application data 275 comprises data obtained or used in connection with executing an application such as an application for training a forecast model, an application for using a forecast model to generate a forecast, an application executing a hashing function (e.g., an application to perform perceptive hashing on an image), an application executing an image encoding, an application for grouping samples (e.g., determining image groupings), an application to extract information from connection requests, authentication requests, webpage content, an input string, an application to extract information from a file, or other sample, etc. In embodiments, the application comprises one or more applications that perform one or more of receive and/or execute a query or task, generate a report and/or configure information that is responsive to an executed query or task, and/or provide to a user information that is responsive to a query or task. Other applications comprise any other appropriate applications (e.g., an index maintenance application, a communications application, a machine learning model application, an application for detecting suspicious authentication requests, an application for detecting malicious network traffic or malicious/non-compliant applications such as with respect to a corporate security policy, a document preparation application, a report preparation application, a user interface application, a data analysis application, an anomaly detection application, a user authentication application, a security policy management/update application, etc.).

Although the foregoing example is described with respect to ingress emails, a similar parsing of emails and rewriting of embedded links can be implemented with respect to egress emails. Specifically, system 200 can undo the rewriting of the embedded links if the email is destined to a recipient outside the domain/organization (e.g., the domain for the sender which receives the security service) so that the links embedded in the egress email no longer include the redirect or envelope data structure. Additionally, or alternatively, system 200 can rewrite the embedded links for egress emails destined for another user within the same domain (e.g., another user that is protected by the security service and for which policies can be enforced). The rewritten links in the egress emails are configured to include the new context for the new intended recipient (e.g., the user to which the email is being forwarded) so that system 200 can enforce the appropriate policies.

FIGS. 3A and 3B are block diagrams of a system for processing emails to secure embedded links according to various embodiments. In some embodiments, system 300 is implemented at least in part by system 100 of FIG. 1 and/or system 200. In the example shown, user 305 uses a user device (e.g., an unmanaged device) to connect to an email server 310, such as via an email application running on the user's device. The security service for securing embedded links can implement system 300 to process the emails, such as to intercept the emails and parse the emails to determine context information for the emails.

System 300 uses ingress multi-tenant cluster 315 to intercept the email, such as by retrieving or obtaining the email from email server 310 (e.g., an exchange server) before the email is delivered to the intended recipient (e.g., user 305). In response to intercepting an inbound email, the inbound email is provided to inbound remote browser isolation (RBI) cluster 320 for processing, which stores the email in a cloud storage bucket 325.

Inbound RBI cluster 320 can instantiate RBI filter 335 to process a particular email. The RBI filter 335 obtains uses parsing module 340 to parse the email and obtain context information. As illustrated, parsing module 340 obtains the email headers, and extracts the user identifier, and tenant information. Additionally, parsing module 340 queries policy store 370 for the applicable policies to be enforced based on the extracted context information (e.g., user identifier, tenant identifier, link category type(s), etc.). Parsing module 340 can store the email data (e.g., the URL link and context information) in cloud storage bucket 345. If parsing module 340 determines that the email does not have any embedded links, parsing module 340 can provide the email to egress cluster 330, which provides the email to email server 310 for delivery to the intended recipient.

System 300 uses link rewriting module 350 to obtain the email content and policy information, such as from parsing module 340 and/or advance URL filter (AUF) module 355. For example, link rewriting module 350 scrapes (or causes AUF module 355 to scrape) the URLs and obtains URL information from the AUF module 355. Link rewriting module 350 can obtain an encoding for the URL link by querying JWT module 360. JWT module 360 can create a URL link encoding using JSON web encryption (JWE) for the tenant, and encodes the user identifier, the tenant identifier, and the URL link.

After rewriting the URL links and updating the email to comprise the rewritten URL links (e.g., system 300 replaces the initial URL links with rewritten URL links that include a redirection through a security service), link rewriting module 350 provides the updated email to egress cluster 330, which provides the updated email to email server 310.

User 305 can access a rewritten URL link, such as by clicking on the rewritten link in an email. In response to clicking on the URL link, a request is sent to system 300, and specifically to RBI portal service 375. RBI portal service 375 retrieves the URL (e.g., from the cookie associated with the request invoked by the user clicking the rewritten link) and context information associated with the email. For example, RBI portal service 375 extracts from the rewritten link a tenant identifier, a user identifier, and optionally other context information. RBI portal service 375 can cause the user to be authenticated, and upon authenticating the user (or invoking authentication of the user by an authentication service), RBI portal service 375 decodes (e.g., decrypts the JWT) to extract the original URL link. RBI portal service 375 can provide the original URL to the applicable RBI stack for the link to be accessed in an isolation context.

FIG. 4 is a flow diagram of a method for enforcing a policy to be applied with respect to an ingress communication according to various embodiments. In some embodiments, process 400 is implemented at least in part by system 100 of FIG. 1, system 200 of FIG. 2, and/or system 300 of FIGS. 3A and 3B. Process 400 may be implemented by an inline security entity, or a cloud security entity or service. Process 400 may be performed in connection with securing communications (e.g., emails, instant messages, etc.) for unmanaged devices, such as personal laptops and phones.

In some implementations, process 400 may be implemented by one or more servers, such as in connection with providing a service to a network (e.g., a security entity and/or a network endpoint such as a client device). In some implementations, process 400 may be implemented by a security entity (e.g., a firewall) such as in connection with enforcing a security policy with respect to traffic from/to domains across a network or in/out of the network.

In some embodiments, process 400 is invoked before the email is placed in the email inbox for the intended recipient (e.g., a first user). For example, the system performs process 400 in response to the email being ingress to a domain, such for inbound emails to a user's Microsoft exchange or Gmail address. The system can intercept the ingress emails, inspect the emails for embedded links, and configure the embedded links to be accessible in a secure manner.

At 405, the system parses an email. In response to obtaining the email, the system parses the email to obtain embedded links and context information. The system can use an email processing engine, such as a remote browser isolation email processing engine (RES) to parse the email. The RES can extract a user identifier (or other indication of the associated user) and various links from the email.

According to various embodiments, the context information comprises an indication of the intended recipient (e.g., a user identifier). The context information may further comprise and (i) an indication of a tenant or organization with which the intended recipient is associated (e.g., a tenant identifier, etc.), (ii) domain information, and (iii) a link category(ies) for the embedded links, etc.

In some embodiments, a first set of context information is comprised in the email. Examples of context information that may be comprised in the email include, without limitation, an indication of the intended recipient (e.g., the intended recipient's email address, or associated user information), an indication of the tenant, etc. The indication of the tenant may be a tenant identifier, or the domain associated with the intended recipient with which the system can query a mapping of domains to tenants to obtain the tenant identifier. Similarly, the indication of the intended recipient may be a user identifier (e.g., a profile identifier associated with the tenant), or the intended recipient's email address or other associated user information (e.g., name, username, etc.) with which the system can query a mapping of user information or email addresses to user identifiers.

At 410, the system identifies a URL link in the email. For example, the system determines the address associated with the URL link. According to various embodiments, in response to identifying the URL link(s) in the email, the system categorizes the URL link(s). For example, the system determines the category for each URL link embedded in the email. Examples of categories may include, without limitation, news, sports, gambling, adult material, etc.

At 415, the system rewrites the URL link for execution in an isolation context based at least in part on a policy. In some embodiments, the system rewrites the URL link in a manner that upon selection of the corresponding rewritten URL link, rather than causing the client system to directly navigate to the URL link, content for the address associated with the URL link is accessed by a remote browser isolation context and provided to the client system in a secure manner.

The rewriting the URL link(s) may include generating an envelope data structure comprising an address for the URL link, a redirect to an isolation system (e.g., a remote browser isolation (RBI) service), and context information (e.g., a user identifier, a tenant identifier, a link category, policy information, etc.). For example, the system embeds context into the rewritten URL link via the generated envelope data structure. Accordingly, upon selection of the rewritten URL link, the client system is redirected to the isolation system/service, which accesses the content at the address for the URL link (e.g., in an isolated environment, such as a virtual machine spun up for the associated tenant) and provides content hosted at the address in a secure manner, such as by enforcing one or more policies with respect to the content.

The system uses the context information associated with the email to determine one or more policies to be enforced with respect to the URL link(s) (e.g., content hosted at the address corresponding to the URL link). For example, the system determines one or more policies applicable to a particular user and the particular tenant associated with the email. The policy applicable for a particular user may be specifically defined for the user profile. Additionally, or alternatively, the policy defined for a set of users according to a predefined grouping of users, such as based on role, department, organization, etc. Certain policies may define how certain content is to be handled, such as whether the content is to be provided to the requesting user, hidden or redacted from the requesting user, etc. Further, the certain policies may define how to handle different types of content differently, such as based on the category of information (e.g., the category for the URL link). As an example, a URL link having a category of news (or specifically for a reputable news website) may be delivered to the user without any further processing (e.g., without causing the content to be redacted, filtered, or without accessing the content via an isolation context, etc.).

In some embodiments, the system rewrites the URL link so that when a user selects the rewritten URL link from the email (e.g., the updated email comprising the rewritten link), the client system is redirected to an applicable content delivery network (CDN) (e.g., the CDN associated with the user or the organization/tenant with which the user is associated). At the CDN, the system extracts an envelope data structure from the rewritten URL link. The system extracts out all the context at has been inserted into the envelope data structure such as user identifier, tenant identifier. The context may further include an indication of the policies to be enforced for the email (e.g., the policies applicable to the user and the tenant with which the user is affiliated). The system authenticates the user using a standard workflow, such as by using a standard proxy service. Once authenticated, the system uses the context embedded in the envelope data structure to redirect the system into an isolation service (e.g., an isolation context service, such as a remote browser isolation (RBI) service). The system extracts the context, for example, so the system can identify the user (or the client system associated with the user that received the email) clicking on the rewritten link to enable the system to determine the applicable policies pertaining to the user or other context characteristics that are to be enforced when providing the content accessible at the address for the URL link. The isolation service accesses the address associated with the URL link, initiates an isolation session at the client system (e.g., isolates a frame provided by the browser to create an isolation endpoint), and sends content accessed at the address to the isolation endpoint.

At 420, a determination is made as to whether process 400 is complete. In some embodiments, process 400 is determined to be complete in response to a determination that no further emails are to be processed, no further embedded links (e.g., URL links) are to be rewritten, an administrator indicates that process 400 is to be paused or stopped, etc. In response to a determination that process 400 is complete, process 400 ends. In response to a determination that process 400 is not complete, process 400 returns to 405.

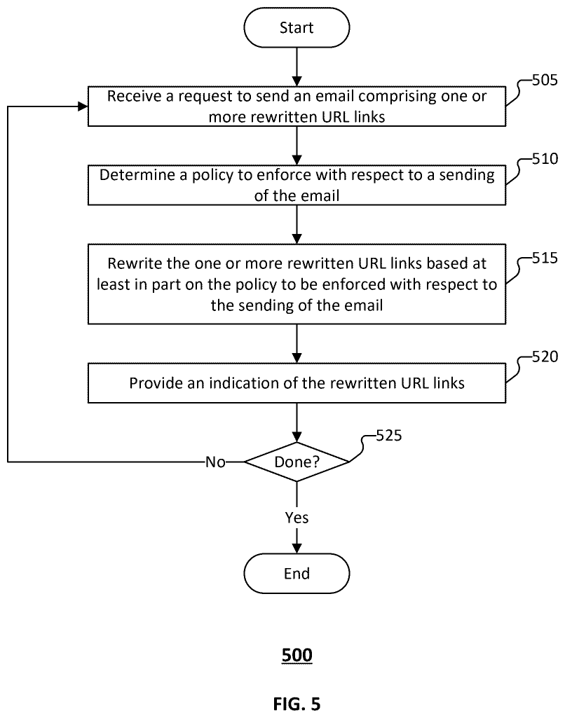

FIG. 5 is a flow diagram of a method for processing an egress communication to unwind enforcement of a particular policy according to various embodiments. In some embodiments, process 500 is implemented at least in part by system 100 of FIG. 1, system 200 of FIG. 2, and/or system 300 of FIGS. 3A and 3B. Process 500 may be implemented by an inline security entity, or a cloud security entity or service.

In some implementations, process 500 may be implemented by one or more servers, such as in connection with providing a service to a network (e.g., a security entity and/or a network endpoint such as a client device). In some implementations, process 500 may be implemented by a security entity (e.g., a firewall) such as in connection with enforcing a security policy with respect to traffic from/to domains across a network or in/out of the network. Process 500 may be performed in connection with securing communications (e.g., emails, instant messages, etc.) for unmanaged devices, such as personal laptops and phones.

At 505, the system receives a request to send an email comprising one or more URL links. For example, the system intercepts an egress email before sending the egress email to the intended recipient (e.g., a second user).

At 510, the system determines a policy to enforce with respect to a sending of the email. In some embodiments, the system determines the policy to be enforced based at least in part on the context information associated with the intended recipient of the egress email. For example, the system determines whether a particular policy is to be applied specifically for the particular intended recipient (e.g., a policy associated with the intended recipient or a role or organization with which the intended recipient is associated) or a tenant with which the intended recipient is associated.

In some embodiments, the system determines that no policy is to be applied to the egress email. However, the system determines to rewrite the rewritten URL links before sending the email. For example, the system unwinds the rewriting of the URL links that occurred when the email was ingress to the sender's inbox (e.g., the first user's inbox). Because the URLs links were initially rewritten to provide a security service for the first user when the first user received the email (e.g., before the first user had input a request to send the email to a second user). The rewritten URL links were rewritten specifically for the first user, such as by including credential information for the first user (e.g., the user identifier), an indication of a remote context to which the accessing of the URL links is to be redirected, and/or a policy or an indication of a policy to be enforced for the first user (e.g., one or more policies for the first user, the tenant with which the first user is associated, etc.).

At 515, the system rewrites the one or more rewritten URL links based at least in part on the policy to be enforced with respect to the sending of the email. The system can rewrite the written URL link to comprise an envelope data structure that is configured specifically for the second user (e.g., the intended recipient of the forwarded email) such as based on the second user's identifier or a tenant with which the sender is associated. Alternatively, if the system will not be providing a security service to the second user/intended recipient, the system can unwind the rewritten URL links (e.g., to extract the address for the URL link and provide the address as a native URL link or in accordance with the initial email that was configured by the system to provide secure access to the URL link).

At 520, the system provides an indication of the rewritten URL links. For example, the system updates the email before the email is sent to the intended recipient.

At 525, a determination is made as to whether process 500 is complete. In some embodiments, process 500 is determined to be complete in response to a determination that no further emails are to be processed, no further embedded links (e.g., URL links) are to be rewritten or unwound, an administrator indicates that process 500 is to be paused or stopped, etc. In response to a determination that process 500 is complete, process 500 ends. In response to a determination that process 500 is not complete, process 500 returns to 505.

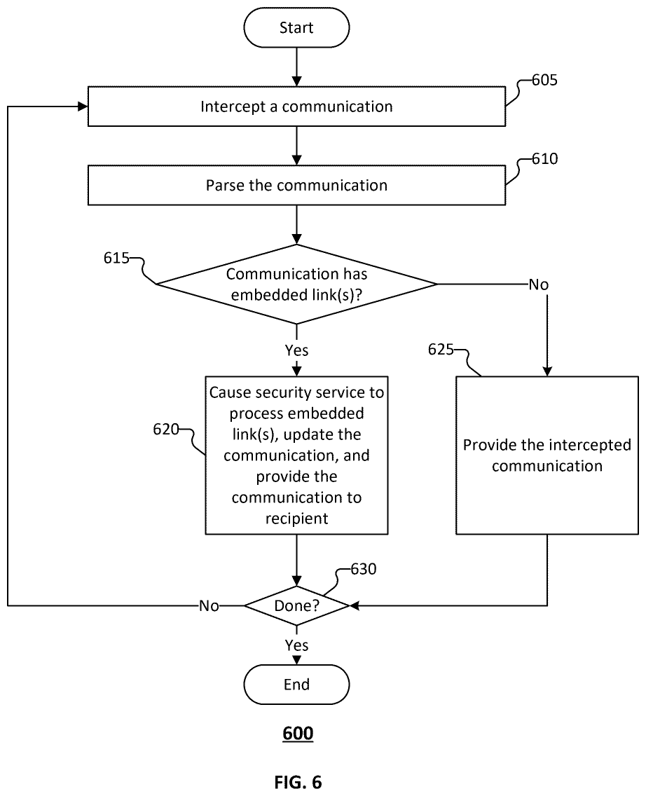

FIG. 6 is a flow diagram of a method for intercepting a communication and processing an embedded link(s) according to various embodiments. In some embodiments, process 600 is implemented at least in part by system 100 of FIG. 1, system 200 of FIG. 2, and/or system 300 of FIGS. 3A and 3B. Process 600 may be implemented by an inline security entity, or a cloud security entity or service.

In some implementations, process 600 may be implemented by one or more servers, such as in connection with providing a service to a network (e.g., a security entity and/or a network endpoint such as a client device). In some implementations, process 600 may be implemented by a security entity (e.g., a firewall) such as in connection with enforcing a security policy with respect to traffic from/to domains across a network or in/out of the network.

At 605, the system intercepts a communication. As an example, the communication is an email. However, the communication can correspond to other communication media, such as an instant message in an instant messaging application (e.g., Microsoft Teams, Slack, WhatsApp, etc.), a social networking page in a social networking application or service, a collaboration page (e.g., a Confluence page), etc.

In some embodiments, the system intercepts all incoming emails (e.g., ingress emails) before delivering the email to the recipient's inbox. The system can analyze and perform preprocessing of the incoming emails before providing the emails to the intended recipient. Similarly, the system can intercept all outgoing emails (e.g., egress emails) and analyze and perform preprocessing of the outgoing email before the email is sent.

At 610, the system parses the communication. The system can parse the communication (e.g., the email) in the same or similar manner as at 405 of process 400.

At 615, the system determines whether the communication has an embedded link(s). In response to determining that the communication has an embedded link(s), process 600 proceeds to 620. Conversely, in response to determining that the communication does not have an embedded link, process 600 proceeds to 625.

At 620, the system causes a security service to process the embedded link(s), update the communication, and provide the communication to the recipient. For example, the system invokes a security service to rewrite the embedded link(s) to ensure that the rewritten embedded link(s) are secure for the intended recipient of the communication to access. The system can rewrite the embedded link(s) by generating an envelope data structure that comprises the address for the embedded link(s) and context information that is used to enforce a security policy with respect to the intended recipient accessing the rewritten embedded link(s). After the security service rewrites the embedded link(s), the system updates the communication to comprise the rewritten embedded link(s) (e.g., rather than the link(s) that were embedded in the communication), and provides the updated communication to the recipient of the communication (e.g., the intended recipient for whom the email was intended). The providing the communication to the recipient may include providing the updated communication to the inbox for the intended recipient (e.g., rather than providing the original communication with the initial embedded link(s) that may be to suspicious or malicious domains, etc.).

At 625, the system provides the intercepted communication. In response to determining that the communication does not comprise an embedded link(s), the system provides the communication to the intended recipient, such as to the intended recipient's inbox.

At 630, a determination is made as to whether process 600 is complete. In some embodiments, process 600 is determined to be complete in response to a determination that no further emails are to be processed, no further embedded links (e.g., URL links) are to be rewritten, an administrator indicates that process 600 is to be paused or stopped, etc. In response to a determination that process 600 is complete, process 600 ends. In response to a determination that process 600 is not complete, process 600 returns to 605.

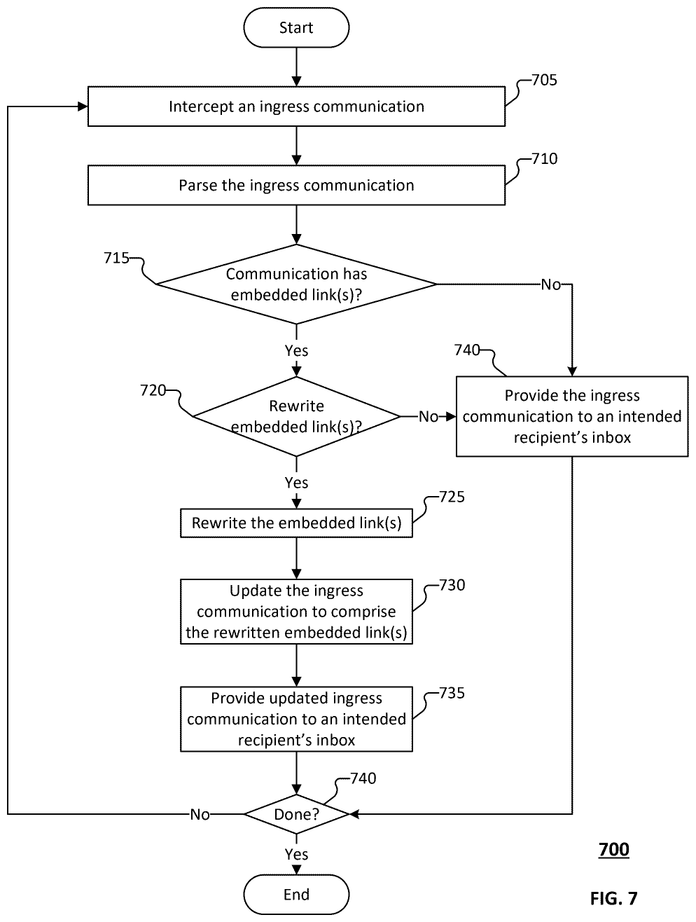

FIG. 7 is a flow diagram of a method for intercepting an ingress communication and processing an embedded link(s) according to various embodiments. In some embodiments, process 800 is implemented at least in part by system 100 of FIG. 1, system 200 of FIG. 2, and/or system 300 of FIGS. 3A and 3B. Process 700 may be implemented by an inline security entity, or a cloud security entity or service.

In some implementations, process 700 may be implemented by one or more servers, such as in connection with providing a service to a network (e.g., a security entity and/or a network endpoint such as a client device). In some implementations, process 700 may be implemented by a security entity (e.g., a firewall) such as in connection with enforcing a security policy with respect to traffic from/to domains across a network or in/out of the network.

At 705, the system intercepts an ingress communication. At 710, the system parses the ingress communication. At 715, the system determines whether the ingress communication has an embedded link(s). In response to determining that the ingress communication has an embedded link(s), process 700 proceeds to 720. Conversely, in response to determining that the ingress communication does not have an embedded link(s), process 700 proceeds to 740. At 720, the system determines whether to rewrite the embedded link(s). In response to determining to rewrite the embedded link(s), the system proceeds to 725. Conversely, in response to determining to not to rewrite the embedded link(s), process 700 proceeds to 740. At 725, the system rewrites the embedded link(s). At 730, the system updates the ingress communication to comprise the rewritten embedded link(s). At 735, the system provides the updated ingress communication to an intended recipient's box. At 740, a determination is made as to whether process 700 is complete. In some embodiments, process 700 is determined to be complete in response to a determination that no further emails are to be processed, no further embedded links (e.g., URL links) are to be rewritten, an administrator indicates that process 700 is to be paused or stopped, etc. In response to a determination that process 700 is complete, process 700 ends. In response to a determination that process 700 is not complete, process 700 returns to 705.

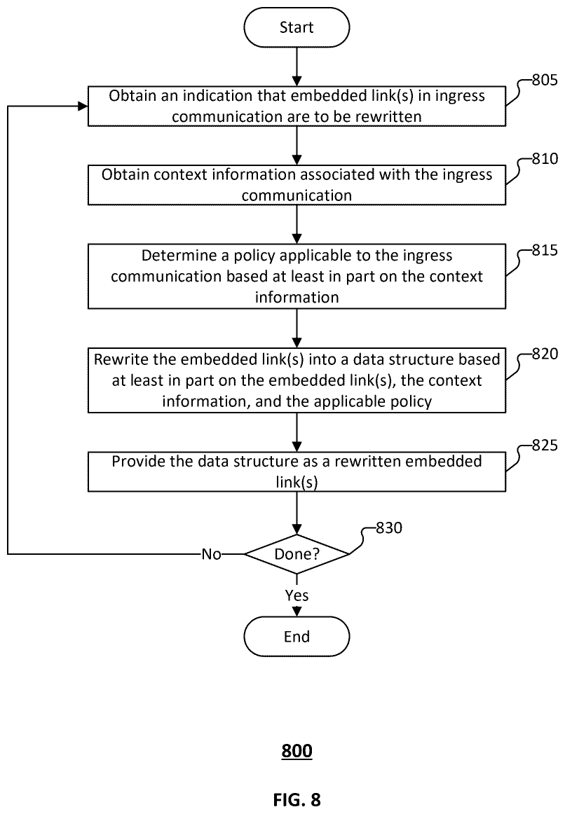

FIG. 8 is a flow diagram of a method for rewriting an embedded link(s) in an ingress communication according to various embodiments. In some embodiments, process 800 is implemented at least in part by system 100 of FIG. 1, system 200 of FIG. 2, and/or system 300 of FIGS. 3A and 3B. Process 800 may be implemented by an inline security entity, or a cloud security entity or service.

In some implementations, process 800 may be implemented by one or more servers, such as in connection with providing a service to a network (e.g., a security entity and/or a network endpoint such as a client device). In some implementations, process 800 may be implemented by a security entity (e.g., a firewall) such as in connection with enforcing a security policy with respect to traffic from/to domains across a network or in/out of the network.

In some embodiments, process 800 is invoked by process 400 of FIG. 4 (e.g., at 415 of process 400) and/or by process 700 of FIG. 7 (e.g., at 725 of process 700).

At 805, the system obtains an indication that embedded link(s) in ingress communication are to be rewritten. At 810, the system obtains context information associated with the ingress communication. At 815, the system determines a policy applicable to the ingress communication based at least in part on the context information. At 820, the system rewrites the embedded link(s) into a data structure based at least in part on the embedded link(s), the context information, and the applicable policy. At 825, the system provides the data structure as a rewritten embedded link(s). At 830, a determination is made as to whether process 800 is complete. In some embodiments, process 800 is determined to be complete in response to a determination that no further emails are to be processed, no further embedded links (e.g., URL links) are to be rewritten, an administrator indicates that process 800 is to be paused or stopped, etc. In response to a determination that process 800 is complete, process 800 ends. In response to a determination that process 800 is not complete, process 800 returns to 805.

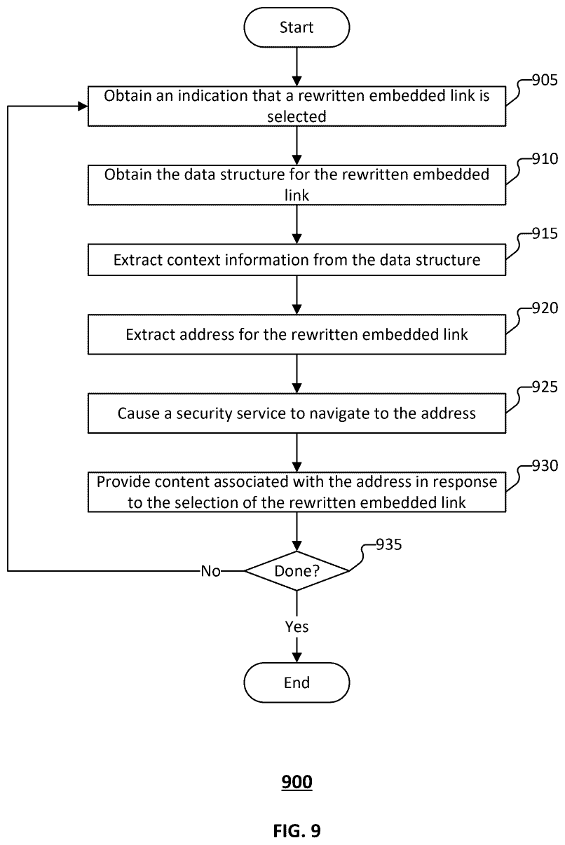

FIG. 9 is a flow diagram of a method for accessing an embedded link in a communication according to various embodiments. In some embodiments, process 900 is implemented at least in part by system 100 of FIG. 1, system 200 of FIG. 2, and/or system 300 of FIGS. 3A and 3B. Process 900 may be implemented by an inline security entity, or a cloud security entity or service.

In some implementations, process 900 may be implemented by one or more servers, such as in connection with providing a service to a network (e.g., a security entity and/or a network endpoint such as a client device). In some implementations, process 900 may be implemented by a security entity (e.g., a firewall) such as in connection with enforcing a security policy with respect to traffic from/to domains across a network or in/out of the network.

At 905, the system obtains an indication that a rewritten embedded link is selected. At 910, the system obtains the data structure for the rewritten embedded link. For example, the system obtains the At 915, the system extracts context information from the data structure. For example, the system extracts a user identifier and a policy identifier or other policy characteristics such as a rule to be enforced. Additionally, the context information may include a tenant identifier and redirect information for redirecting access to the URL link to an isolation context. At 920, the system extracts the address for the rewritten embedded link. At 925, the system causes a security service to navigate to the address. The system causes the security service to access the address in an isolated context (e.g., a sandbox, or other container that is spun up in a cluster of virtual machines, etc.). In the isolated context, the system can determine whether any content is malicious or suspicious or otherwise content for which the user does not have appropriate permissions, and in response to identifying such content from being communicated (e.g., to the client system). At 930, the system provides content associated with the address in response to the selection of the rewritten embedded link. The system can filter out the malicious or suspicious or otherwise content for which the user does not have appropriate permissions and send the remaining content, if any, to the client system. At 935, a determination is made as to whether process 900 is complete. In some embodiments, process 900 is determined to be complete in response to a determination that no further emails are to be processed, no further embedded links (e.g., URL links) are to be accessed, no further rewritten embedded links are selected, an administrator indicates that process 900 is to be paused or stopped, etc. In response to a determination that process 900 is complete, process 900 ends. In response to a determination that process 900 is not complete, process 900 returns to 905.

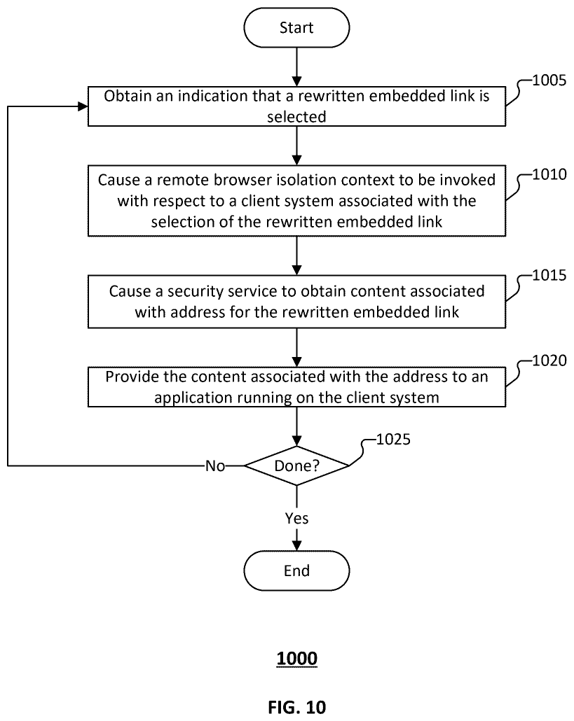

FIG. 10 is a flow diagram of a method for accessing an embedded link in a communication according to various embodiments. In some embodiments, process 1000 is implemented at least in part by system 100 of FIG. 1, system 200 of FIG. 2, and/or system 300 of FIGS. 3A and 3B. Process 1000 may be implemented by an inline security entity, or a cloud security entity or service.

In some implementations, process 1000 may be implemented by one or more servers, such as in connection with providing a service to a network (e.g., a security entity and/or a network endpoint such as a client device). In some implementations, process 1000 may be implemented by a security entity (e.g., a firewall) such as in connection with enforcing a security policy with respect to traffic from/to domains across a network or in/out of the network.

In some embodiments, process 1000 is invoked by process 900 of FIG. 9, such as at 925 of process 900.

At 1005, the system obtains an indication that a rewritten embedded link is selected. At 1010, the system causes a remote browser isolation (RBI) context to be invoked with respect to a client system associated with the selection of the rewritten embedded link. At 1015, the system causes a security service to obtain content associated with the address for the rewritten embedded link. At 1020, the system provides the content associated with the address to an application running on the client system. At 1025, a determination is made as to whether process 1000 is complete. In some embodiments, process 1000 is determined to be complete in response to a determination that no further emails are to be processed, no further embedded links (e.g., URL links) are to be accessed, no further rewritten embedded links are selected, an administrator indicates that process 1000 is to be paused or stopped, etc. In response to a determination that process 1000 is complete, process 1000 ends. In response to a determination that process 1000 is not complete, process 1000 returns to 1005.

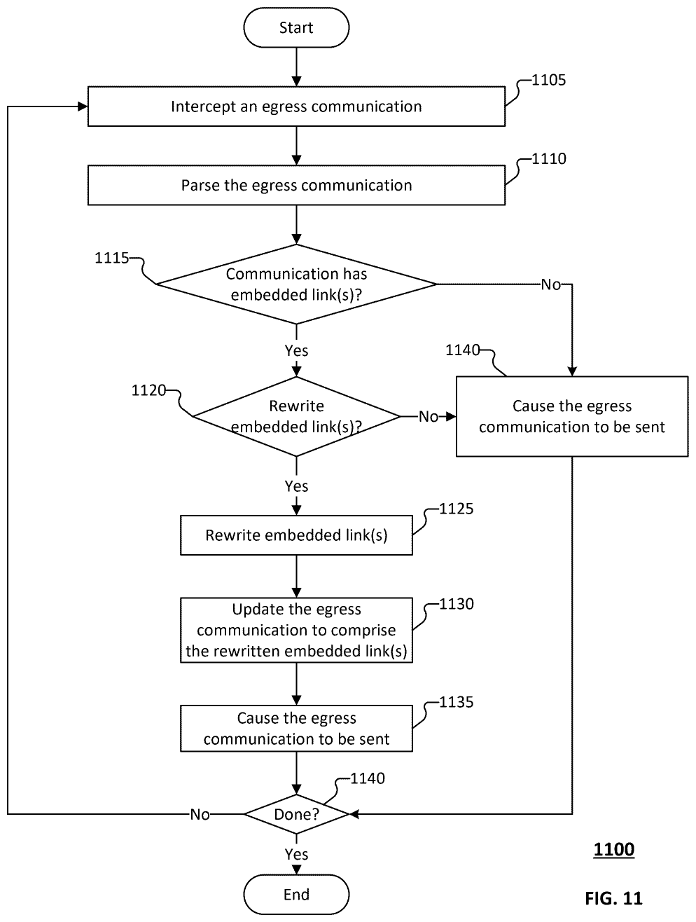

FIG. 11 is a flow diagram of a method for intercepting an egress communication and processing an embedded link(s) according to various embodiments. In some embodiments, process 1100 is implemented at least in part by system 100 of FIG. 1, system 200 of FIG. 2, and/or system 300 of FIGS. 3A and 3B. Process 1100 may be implemented by an inline security entity, or a cloud security entity or service.

In some implementations, process 1100 may be implemented by one or more servers, such as in connection with providing a service to a network (e.g., a security entity and/or a network endpoint such as a client device). In some implementations, process 1100 may be implemented by a security entity (e.g., a firewall) such as in connection with enforcing a security policy with respect to traffic from/to domains across a network or in/out of the network.

At 1105, the system intercepts an egress communication. The system can be configured to pass all outgoing communications through a security service that, among other things, evaluates whether the communication has any embedded links and, if so, to process the embedded links to either configure the link to be redirected to the applicable service for the intended recipient (e.g., based on the permissions or policy configurations applicable to the intended recipient), or to remove the redirect configuration in any of the embedded links.

At 1110, the system parses the egress communication.

At 1115, the system determines whether the egress communication has an embedded link(s). In response to determining that the egress communication has an embedded link(s), process 1100 proceeds to 1120. Conversely, in response to determining that the egress communication does not have an embedded link(s), process 1100 proceeds to 1140.

At 1120, the system determines whether to rewrite the embedded link(s). In response to determining to rewrite the embedded link(s), the system proceeds to 1125. Conversely, in response to determining to not to rewrite the embedded link(s), process 1100 proceeds to 1140.

At 1125, the system rewrites the embedded link(s). The system performs a policy lookup to determine any policies applicable to the intended recipient (e.g., any policies applicable specifically for the user, the organization or department for which the user belongs, and/or the tenant with which the user is associated). The applicable policy may specify one or more rules pertaining to how a link is to be redirected (e.g., a redirect address for an isolation context), what types of information/content is to be provided to the user (e.g., identify specific contents for which the user does not have permissions, etc.), etc.

At 1130, the system updates the egress communication to comprise the rewritten embedded link(s). For example, the system replaces the existing embedded links with the rewritten embedded links.

At 1135, the system causes the egress communication to be sent. As an example, if the intended recipient is within the same domain, the system can store the egress communication to the intended recipient's inbox. As another example, if the intended recipient is not within the same domain (e.g., is associated with a different domain or tenant), the system communicates the egress communication.

At 1140, a determination is made as to whether process 1100 is complete. In some embodiments, process 1100 is determined to be complete in response to a determination that no further emails are to be processed, no further embedded links (e.g., URL links) are to be rewritten, an administrator indicates that process 1100 is to be paused or stopped, etc. In response to a determination that process 1100 is complete, process 1100 ends. In response to a determination that process 1100 is not complete, process 1100 returns to 1105.

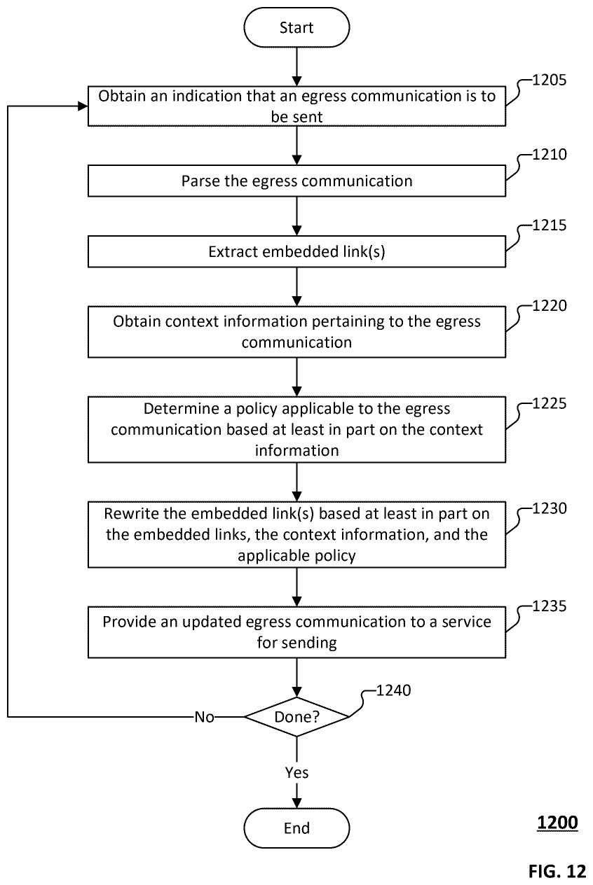

FIG. 12 is a flow diagram of a method for processing an embedded link(s) for an egress communication according to various embodiments. In some embodiments, process 1200 is implemented at least in part by system 100 of FIG. 1, system 200 of FIG. 2, and/or system 300 of FIGS. 3A and 3B. Process 1200 may be implemented by an inline security entity, or a cloud security entity or service.

In some implementations, process 1200 may be implemented by one or more servers, such as in connection with providing a service to a network (e.g., a security entity and/or a network endpoint such as a client device). In some implementations, process 1200 may be implemented by a security entity (e.g., a firewall) such as in connection with enforcing a security policy with respect to traffic from/to domains across a network or in/out of the network.

At 1205, the system obtains an indication that an egress communication is to be sent. At 1210, the system parses the egress communication. At 1215, the system extracts embedded link(s). At 1220, the system obtains context information pertaining to the egress communication. At 1225, the system determines a policy applicable to the egress communication based at least in part on the context information. At 1230, the system rewrites the embedded link(s) based at least in part on the embedded links, the context information, and the applicable policy. At 1235, the system provides an updated egress communication to a service for sending. At 1240, a determination is made as to whether process 1200 is complete. In some embodiments, process 1200 is determined to be complete in response to a determination that no further emails are to be processed, no further embedded links (e.g., URL links) are to be rewritten, an administrator indicates that process 1200 is to be paused or stopped, etc. In response to a determination that process 1200 is complete, process 1200 ends. In response to a determination that process 1200 is not complete, process 1200 returns to 1205.

Although various embodiments described herein pertain to the rewriting of links comprised in (e.g., embedded) an email, the techniques described herein (e.g., the securing or rewriting of links) can be implemented to rewrite links embedded in other communication media such as instant messaging applications, documents (e.g., word documents, PDF documents, power point documents, etc.), collaboration documents or pages (e.g., a Confluence™ page, etc.).

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

1. A system, comprising:
one or more processors configured to:
parse an email;
identify a URL link in the email;
rewrite the URL link for execution in an isolation context based at least in part on a policy; and
a memory coupled to the one or more processors and configured to provide one or more processors with instructions.

2. The system of claim 1, wherein the email is an inbound email.

3. The system of claim 1, wherein the URL links are rewritten before the URL is provided to a mailbox for an intended recipient of the email.

4. The system of claim 1, wherein executing the link in the isolation context comprises using a container to process content associated with the URL in a cloud security service.

5. The system of claim 1, wherein the one or more processors are further configured to:
replace the URL in the email with the rewritten URL link to obtain a secure email; and
provide the secure email to an inbox for an intended recipient of the email.

6. The system of claim 1, wherein the one or more processors are further configured to:
determine whether to rewrite the URL link for execution in the isolated context based at least in part on the policy.

7. The system of claim 6, wherein:
the one or more processors are further configured to obtain an identifier for an intended recipient of the email; and
determining whether to rewrite the URL link comprises querying the policy, wherein the policy is identified based at least in part on the identifier for the intended recipient.

8. The system of claim 1, wherein the policy comprise a set of one or more rules dependent on one or more characteristics associated with the email.

9. The system of claim 8, wherein the one or more characteristics comprises a characteristic for at least one of a sender of the email, an intended recipient of the email, and a category associated with the URL link.

10. The system of claim 9, wherein the characteristics for the intended recipient of the email comprises one or more of a user identifier and a tenant identifier.

11. The system of claim 8, wherein the one or more rules pertain to inspection, downloading, or data loss prevention.

12. The system of claim 1, wherein the one or more processors are further configured to:
obtain from the email a user identifier and tenant information; and
perform a policy lookup to obtain the policy, wherein the policy lookup is performed based at least in part on the user identifier and the tenant information.

13. The system of claim 1, wherein the one or more processors are further configured to obtain email header information from the email.

14. The system of claim 1, wherein the URL link is rewritten specific for an intended recipient of the email.

15. The system of claim 1, wherein rewriting the URL link comprises generating an envelope data structure comprising the URL and a set of metadata.

16. The system of claim 15, wherein the set of metadata comprises a context associated with the email or an intended recipient of the email.

17. The system of claim 1, wherein the envelope is used to facilitate applying a policy in connection with a clicking of the rewritten URL link embedded in the email.

18. The system of claim 1, wherein:
the URL link is rewritten in connection with a first user receiving the email;
the one or more processors are further configured to:
receive, from the first user, a request to send to a second user the email comprising the rewritten URL link; and
in response to receiving the request, rewrite the rewritten URL link based at least in part on the second user.

19. The system of claim 18, wherein rewriting the rewritten URL link comprises unwinding the rewriting of the URL link.

20. The system of claim 19, wherein the rewritten URL link is embedded in an envelope data structure embedded in the email, and the unwinding the rewritten URL link based at least in part on extracting address for the URL link from the envelope data structure and inserting a native link to the address for the URL link.

21. The system of claim 18, wherein the rewritten URL link is further rewritten based at least in part on a policy to be enforced with respect to the second user.

22. A method, comprising:
parsing an email;
identifying a URL link in the email; and
rewriting the URL link for execution in an isolation context based at least in part on a policy.

23. A computer program product embodied in a non-transitory computer readable medium and comprising computer instructions for:
parsing an email;
identifying a URL link in the email; and
rewriting the URL link for execution in an isolation context based at least in part on a policy.

24. A method, comprising:
receiving a request to send an email comprising one or more rewritten URL links;
determining a policy to enforce with respect to a sending of the email;
rewriting the one or more rewritten URL links based at least in part on the policy to be enforced with respect to the sending of the email;
modify the email based on the rewriting of the one or more rewritten URL links; and
causing the email to be sent.
